(19) United States
(12) Patent Application Publication
(10) Pub. No.: US 2021/0214530 A1
(43) Pub. Date: Jul. 15, 2021

(54) TIRE PROVIDED WITH AN OUTER SIDEWALL COMPRISING ONE OR MORE THERMOPLASTIC ELASTOMERS AND ONE OR MORE SYNTHETIC DIENE ELASTOMERS

(71) Applicant: COMPAGNIE GENERALE DES ETABLISSEMENTS MICHELIN, Clermont-Ferrand (FR)

(72) Inventors: CHRISTOPHE CHOUVEL, Clermont-Ferrand (FR); DAVID GONZALEZ, Clermont-Ferrand (FR)

(21) Appl. No.: 17/059,902

(22) PCT Filed: May 17, 2019
(86) PCT No.: PCT/FR2019/051124

§ 371 Date: Nov. 30, 2020

(30) Foreign Application Priority Data
May 31, 2018 (FR) 1854660

(51) Int. Cl. C08L 9/00; B60C 1/00

(52) U.S. Cl. CPC C08L 9/00; C08L 2205/03; C08L 2312/00; B60C 1/0025

(57) ABSTRACT

A tire is provided with an external sidewall comprising at least one composition based on at least one elastomeric matrix comprising at least one diene elastomer selected from the group consisting of butadiene polymers having a glass transition temperature of less than or equal to −50° C., and a thermoplastic elastomer comprising at least one elastomer block and at least one thermoplastic block, the thermoplastic elastomer not comprising a polyisobutylene block; a crosslinking system; a reinforcing filler; the composition not comprising antiozone wax or comprising less than 1 phr thereof.

The present invention relates to tyres and more particularly to tyre external sidewalls, that is to say, by definition, to elastomeric layers located radially on the outside of the tyre, which are in contact with the ambient air.

It is possible to define, within the tyre, three types of regions:
The radially exterior region in contact with the ambient air, this region being essentially composed of the tread and of the external sidewall of the tyre. An external sidewall is an elastomeric layer positioned outside the carcass reinforcement with respect to the internal cavity of the tyre, between the crown and the bead, so as to completely or partially cover the region of the carcass reinforcement extending from the crown to the bead.
The radially interior region in contact with the inflation gas, this region generally being composed of the layer airtight to the inflation gas, sometimes known as inner liner.
The internal region of the tyre, that is to say that between the exterior and interior regions. This region includes layers or plies which are referred to here as internal layers of the tyre. These are, for example, carcass plies, tread underlayers, tyre belt plies or any other layer which is not in contact with the ambient air or the inflation gas of the tyre.

As illustrated by numerous documents, among which mention may be made of the documents EP 1 097 966, EP 1 462 479, EP 1 033 265, EP 1 357 149, EP 1 231 080 and U.S. Pat. No. 4,824,900, the compositions traditionally used for sidewalls are based on natural rubber and on synthetic rubber such as polybutadiene, on carbon black and on antiozone wax.

The external sidewall can, depending on the requirements, comprise one or more protective plies, located on the outside with respect to the carcass reinforcement, the role of which protective plies is to protect the rest of the structure of the sidewall from external attacks: impacts, tears or other perforations.

This is, for example, the case in the sidewalls of certains tyres intended for rolling over relatively rough ground, for example on rally-type passenger vehicles or else on industrial off-road vehicles of the construction site type. These protective plies must be sufficiently flexible and deformable so as, on the one hand, to follow as closely as possible the shape of the obstacle on which the sidewall is liable to bear during rolling and, on the other hand, to prevent the possible penetration of foreign bodies towards the inside of the said sidewall. To meet such criteria generally requires the use, in these protective plies or layers, of reinforcing threads in the form of elastic metal-strand cords combining a high elasticity and a high breaking energy.

Such metallic protective plies for tyre sidewalls are well known; they have been described, for example, in patents or patent applications U.S. Pat. No. 3,464,477 and US 2003/0005993.

However, they exhibit a certain number of disadvantages. Besides the fact that they consequently make the sidewalls of the tyres heavier, they are formed from strand cords which are relatively expensive, on two accounts: first, they are prepared in two stages, namely by prior manufacture of the strands, followed by assembling these strands by twisting; secondly, they generally require a high twist of their wires (i.e., very short helical pitches), a twist which is admittedly essential in order to confer on them the desired elasticity but which involves reduced manufacturing rates. This disadvantage, of course, has repercussions on the cost of the tyres themselves. Consequently, such modifications to the external sidewall are not applicable to tyres intended for passenger vehicles, coach or bus.

Nevertheless, there is a high demand from users to have available tyres, in particular tyres intended for passenger vehicles, coach or bus, which comprise sidewalls resistant to external attacks, such as impacts, tears or other perforations. It concerns in particular the contacts between the tyre and the pavement, which can seriously damage, indeed even perforate, the tyre.

Furthermore, a tyre sidewall must have numerous other features which are sometimes difficult to reconcile, and in particular a good resistance to ozone and a stiffness suited to the external sidewalls for a tyre.

In particular, ozone is known as having harmful effects on rubber articles, typically producing a glazing and/or cracks at the surface of these articles. In order to combat these harmful effects, use is conventionally made of antiozone waxes well known to a person skilled in the art.

There thus also exists a need to minimize these phenomena, in particular without damaging the other properties of the external sidewall.

On continuing its research studies, the Applicant Company has developed a rubber composition for a tyre external sidewall which confers, on said external sidewall, an improved resistance to external attacks, with respect to the external sidewalls of the prior art, by replacing all or part of the natural rubber of the composition with at least one thermoplastic elastomer comprising at least one elastomer block and at least one thermoplastic block, the thermoplastic elastomer not comprising a polyisobutylene block.

The Applicant Company has now discovered, completely unexpectedly, that it is possible to further improve the resistance to ozone of such compositions by reducing the amount of antiozone wax. This effect goes against the teaching of the art, which on the contrary forces a person skilled in the art to increase the amount of antiozone waxes in order to enhance their intrinsic effect. This effect was observed solely for compositions comprising at least one abovementioned thermoplastic elastomer and is not on the other hand observed for compositions based on natural rubber and on polybutadiene.

Thus, a subject-matter of the invention is a tyre provided with an external sidewall, the said external sidewall comprising at least one composition based on at least:
an elastomeric matrix comprising at least one diene elastomer selected from the group consisting of butadiene polymers having a glass transition temperature of less than or equal to −50° C., and a thermoplastic elastomer comprising at least one elastomer block and at least one thermoplastic block, the thermoplastic elastomer not comprising a polyisobutylene block,
a crosslinking system, and
a reinforcing filler,
the composition not comprising antiozone wax or comprising less than 1 phr thereof.

The tyre according to the invention comprising the external sidewall makes it possible to cause the outside attacker “to slide” over the sidewall and in particular prevents the penetration into the sidewall of an outside attacker or at least minimizes the depth to which the sidewall is attacked during the rubbing of the latter over the outside attacker.

Furthermore, this external sidewall does not necessarily comprise protection by metal and it is consequently easier and faster to prepare. Thus, the cost prices of the tyre according to the invention are reduced, in comparison with tyres comprising sidewalls comprising protection by metal.

Finally, this external sidewall exhibits an improved resistance to ozone in comparison with the external sidewalls of the prior art.

The invention and its advantages will be easily understood in the light of the description and implementational examples which follow.

### I—DEFINITIONS

The expression “part by weight per hundred parts by weight of elastomer” (or phr) should be understood as meaning, within the meaning of the present invention, the part by weight per hundred parts by weight of elastomers, whether or not they are thermoplastic. In other words, the thermoplastic elastomers are elastomers.

In the present document, unless expressly indicated otherwise, all the percentages (%) shown are percentages (%) by weight.

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b). In the present document, when an interval of values is denoted by the expression “from a to b”, the interval represented by the expression “between a and b” is also and preferentially denoted.

In the present document, the expression composition “based on” is understood to mean a composition comprising the mixture and/or the reaction product of the various constituents used, some of these constituents being able to react and/or being intended to react with one another, at least partially, during the various phases of manufacture of the composition.

When reference is made to a “predominant” compound, this is understood to mean, within the meaning of the present invention, that this compound is predominant among the compounds of the same type in the composition, that is to say that it is the one which represents the greatest amount by weight among the compounds of the same type, for example more than 50%, 60%, 70%, 80%, 90%, indeed even 100%, by weight, with respect to the total weight of the compound type. Thus, for example, a predominant reinforcing filler is the reinforcing filler representing the greatest weight with respect to the total weight of the reinforcing fillers in the composition.

In the context of the invention, the carbon-comprising compounds mentioned in the description can be of fossil origin or biosourced. In the latter case, they can partially or completely result from biomass or be obtained from renewable starting materials resulting from biomass. Polymers, plasticizers, fillers and the like are concerned in particular.

Unless otherwise indicated, the components described in the present document form part of the external sidewall composition of the tyre according to the present invention. Their respective incorporation contents correspond to their contents in the external sidewall composition of the tyre according to the present invention. Thus, unless otherwise indicated, when the expression “the composition” is used, reference is being made to the external sidewall composition of the tyre according to the present invention.

All the values for glass transition temperature “Tg” described in the present document are measured in a known way by DSC (Differential Scanning calorimetry) according to Standard ASTM D3418 (1999).

### II—DESCRIPTION OF THE INVENTION

II-1 Elastomeric Matrix

The elastomeric matrix of the external sidewall composition of the tyre according to the invention comprises at least one diene elastomer selected from the group consisting of butadiene polymers having a glass transition temperature of less than or equal to −50° C., and a thermoplastic elastomer comprising at least one elastomer block and at least one thermoplastic block, the thermoplastic elastomer not comprising a polyisobutylene block.

II-1-a Diene Elastomer

According to the invention, the elastomeric matrix comprises at least one diene elastomer is selected from the group consisting of butadiene polymers having a glass transition temperature (Tg) of less than or equal to −50° C.

Diene elastomer should be understood, in a known way, as an elastomer resulting at least in part, that is to say a homopolymer or a copolymer, from diene monomers. In a way known per se, a diene monomer is a monomer comprising two conjugated or non-conjugated carbon-carbon double bonds.

Thus, diene elastomers selected from the group consisting of butadiene polymers should be understood as meaning an elastomer resulting at least in part, that is to say a homopolymer or a copolymer, from butadiene monomers.

Preferably, the diene elastomer(s) selected from the group consisting of butadiene polymers having a glass transition temperature of less than or equal to −50° C. are selected from the group consisting of homopolymers obtained by polymerization of a butadiene monomer; copolymers obtained by copolymerization of one or more conjugated diene monomers, at least one of which is a butadiene monomer, with one another or with one or more vinylaromatic compounds having from 8 to 20 carbon atoms; and the mixtures of these polymers (it being understood that these elastomers exhibit a glass transition temperature (Tg) of less than or equal to −50° C.).

The following are suitable in particular as conjugated diener: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, or an aryl-1,3-butadiene.

The following, for example, are suitable as vinylaromatic compounds: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

When the diene elastomer(s) selected from the group consisting of butadiene polymers having a glass transition temperature of less than or equal to −50° C. are selected from copolymers obtained by copolymerization of one or more conjugated diener, at least one of which is a butadiene monomer, with one another or with one or more vinylaromatic compounds having from 8 to 20 carbon atoms, these can contain between 99% and 20% by weight of butadiene units and between 1% and 80% by weight of vinylaromatic units. In this case, the butadiene polymers having a glass transition temperature of less than or equal to −50° C. preferably has between 1% and 50%, more preferably between 0% and 10%, by weight of vinylaromatic units.

The diene elastomer(s) selected from the group consisting of butadiene polymers having a glass transition temperature of less than or equal to −50° C. which can be used according to the invention can have any microstructure, which depends on the polymerization conditions used, in particular on the presence or absence of a modifying and/or randomizing agent and on the amounts of modifying and/or randomizing agent employed.

The diene elastomer(s) selected from the group consisting of butadiene polymers having a glass transition temperature of less than or equal to −50° C. which can be used according to the invention can, for example, be prepared in dispersion or in solution; they can be coupled and/or star-branched or else functionalized with a coupling and/or star-branching or functionalization agent. For coupling with carbon black, mention may be made, for example, of functional groups comprising a C—Sn bond or aminated functional groups, such as benzophenone, for example; for coupling to a reinforcing inorganic filler, such as silica, mention may be made, for example, of silanol functional groups or polysiloxane functional groups having a silanol end (such as described, for example, in FR 2 740 778 or U.S. Pat. No. 6,013,718), alkoxysilane groups (such as described, for example, in FR 2 765 882 or U.S. Pat. No. 5,977,238), carboxyl groups (such as described, for example, in WO 01/92402 or U.S. Pat. No. 6,815,473, WO 2004/096865 or US 2006/0089445) or else polyether groups (such as described, for example, in EP 1 127 909 or U.S. Pat. No. 6,503,973).

Mention may also be made, as other examples of functionalized elastomers, of elastomers (such as SBR or BR) of the epoxidized type.

The following are suitable in particular as diene elastomer selected from the group consisting of butadiene polymers having a glass transition temperature of less than or equal to −50° C. which can be used in the composition of the external sidewall of the tyre according to the invention: polybutadienes having a content (mol %) of 1,2-units of between 4% and 80% or those having a content (mol %) of cis-1,4-units of greater than 80%, butadiene/styrene copolymers and in particular those having a glass transition temperature Tg (measured according to ASTM D3418 (1999)) of between −50° C. and −70° C. and more particularly between −50° C. and −60° C., a styrene content of between 5% and 60% by weight and more particularly between 20% and 50%, a content (mol %) of 1,2-bonds of the butadiene part of between 4% and 75% and a content (mol %) of trans-1,4-bonds of between 10% and 80%, butadiene/isoprene copolymers and especially those having an isoprene content of between 5% and 90% by weight and a Tg of −50° C. to −80° C. In the case of butadiene/styrene/isoprene copolymers, those having a styrene content of between 5% and 50% by weight and more particularly of between 10% and 40%, an isoprene content of between 15% and 60% by weight and more particularly of between 20% and 50%, a butadiene content of between 5% and 50% by weight and more particularly of between 20% and 40%, a content (mol %) of 1,2-units of the butadiene part of between 4% and 85%, a content (mol %) of trans-1,4-units of the butadiene part of between 6% and 80%, a content (mol %) of 1,2-plus 3,4-units of the isoprene part of between 5% and 70% and a content (mol %) of trans-1,4-units of the isoprene part of between 10% and 50%, and more generally any butadiene/styrene/isoprene copolymer having a Tg of between −70° C. and −50° C., are especially suitable.

In a particularly preferred way, the diene elastomer(s) selected from the group consisting of butadiene polymers having a glass transition temperature of less than or equal to −50° C. are selected from the group consisting of polybutadienes (abbreviated to “BRs”), butadiene copolymers, preferably butadiene/styrene copolymers (SBRs), isoprene/butadiene copolymers (BIRs) and isoprene/butadiene/styrene copolymers (SBIRs), and mixtures thereof (it being understood that these elastomers exhibit a glass transition temperature (Tg) of less than or equal to −50° C.).

Preferably again, the diene elastomer(s) selected from the group consisting of butadiene polymers having a glass transition temperature of less than or equal to −50° C. are selected from the group consisting of polybutadienes, butadiene/styrene copolymers and the mixtures of these elastomers (it being understood that these elastomers exhibit a glass transition temperature (Tg) of less than or equal to −50° C.).

Preferably, the content of diene elastomers selected from the group consisting of butadiene polymers having a glass transition temperature of less than or equal to −50° C., in the composition which can be used in the sidewall of the tyre according to the invention, is within a range extending from 50 to 99 phr, preferably from 55 to 95 phr, more preferentially from 60 to 90 phr, more preferentially still from 65 to 85 phr.

II-1-b Thermoplastic Elastomer

According to the invention, the elastomeric matrix comprises at least one thermoplastic elastomer comprising at least one elastomer block and at least one thermoplastic block, the thermoplastic elastomer not comprising a polyisobutylene block.

Unless otherwise indicated, in the present document, when reference is made to “the thermoplastic elastomer”, at least one thermoplastic elastomer comprising at least one elastomer block and at least one thermoplastic block, the thermoplastic elastomer not comprising a polyisobutylene block, is denoted.

Thermoplastic elastomer (TPE) is understood to mean, in a known way, a polymer with a structure which is intermediate between a thermoplastic polymer and an elastomer. A thermoplastic elastomer is formed of one or more rigid “thermoplastic” segments connected to one or more flexible “elastomer” segments.

Thus, the thermoplastic elastomer(s) of the composition of the external sidewall which can be used according to the invention comprise at least one elastomer block and at least one thermoplastic block.

Typically, each of these segments or blocks contains at least more than 5, generally more than 10, base units.

Thus, a composition in which a resin or a thermoplastic polymer and an elastomer are mixed does not constitute a thermoplastic elastomer within the meaning of the present invention.

In the present patent application, when reference is made to the glass transition temperature of a thermoplastic elastomer, it is the glass transition temperature relating to the elastomer block (unless otherwise indicated). This is because, in a known way, thermoplastic elastomers exhibit two glass transition temperature (Tg, measured according to ASTM D3418 (1999)) peaks or one Tg peak (elastomer part of the thermoplastic elastomer) and one melting point peak (thermoplastic parts of the thermoplastic elastomer) (Tf, measured in a well-known manner by DSC according to Standard ASTM D3418). When the thermoplastic elastomer exhibits 2 Tg peaks, the lowest temperature being relative to the elastomer part of the thermoplastic elastomer and the highest temperature being relative to the thermoplastic part of the thermoplastic elastomer. Thus, the flexible blocks of the thermoplastic elastomers are generally defined by a Tg of less than or equal to ambient temperature (25° C.), while the rigid blocks have a Tg of greater than or equal to 80° C. In order to be both elastomeric and thermoplastic in nature, the thermoplastic elastomer has to be provided with blocks which are sufficiently incompatible (that is to say, different as a result of their respective weights, their respective polarities or their respective Tg values) to retain their own properties of elastomer block or thermoplastic block.

Preferentially, the elastomer block of the thermoplastic elastomer exhibits a glass transition temperature of less than or equal to −50° C.

Also preferentially, the glass transition temperature of the thermoplastic elastomers (that is to say, of the elastomer block(s) of the thermoplastic elastomers) which can be used according to the invention is greater than −100° C.

The number-average molecular weight (denoted Mn) of the thermoplastic elastomers is preferentially between 30 000 and 500 000 g/mol, more preferentially between 40 000 and 400 000 g/mol, more preferentially still between 50 000 and 300 000 g/mol. Below the minima indicated, there is a risk of the cohesion between the elastomer chains of the thermoplastic elastomers being affected, in particular due to their possible dilution (in the presence of an extender oil); furthermore, there is a risk of an increase in the working temperature affecting the mechanical properties, in particular the properties at break, with the consequence of a reduced “hot” performance. Furthermore, an excessively high Mn can be detrimental to the processing.

The number-average molecular weight (Mn) of the thermoplastic elastomers is determined in a known way, by size exclusion chromatography (SEC). The sample is dissolved beforehand in a suitable solvent at a concentration of approximately 2 g/l and then the solution is filtered through a filter with a porosity of 0.45 μm before injection. The apparatus used is a Waters Alliance chromatographic line. The injected volume of the solution of the polymer sample is 100 μl. The detector is a Waters 2410 differential refractometer and its associated software, for making use of the the chromatographic data, is the Empower system. The conditions can be adjusted by a person skilled in the art. For example, in the case of TPEs of COPE type, the elution solvent is hexafluoroisopropanol with sodium trifluoroacetate salt at a concentration of 0.02M, the flow rate is 0.5 ml/min, the temperature of the system is 35° C. and the analytical time is 90 min. Use is made of a set of three Phenomenex columns in series, with “Phenogel” commercial names (pore size: 105, 104, 103 A). For example, in the case of thermoplastic styrene elastomers, the sample is dissolved beforehand in tetrahydrofuran at a concentration of approximately 1 g/l and then the solution is filtered through a filter with a porosity of 0.45 μm before injection. The apparatus used is a Waters Alliance chromatographic line. The elution solvent is tetrahydrofuran, the flow rate is 0.7 ml/min, the temperature of the system is 35° C. and the analytical time is 90 min. A set of four Waters columns in series, with Styragel commercial names (HMW7, HMW6E and two HT6E), is used. The injected volume of the solution of the polymer sample is 100 μl. The detector is a Waters 2410 differential refractometer and its associated software, for making use of the chromatographic data, is the Waters Millennium system. The calculated average molar masses are relative to a calibration curve produced with polystyrene standards.

The polydispersity index (PI=Mw/Mn, with Mw the weight-average molecular weight) of the thermoplastic elastomer(s) is preferably less than 3, more preferentially less than 2 and more preferentially still less than 1.5.

The thermoplastic elastomers which can be used according to the invention can be copolymers with a small number of blocks (less than 5, typically 2 or 3), in which case these blocks preferably have high weights/masses of greater than 15 000 g/mol.

The thermoplastic elastomers can also be copolymers with a large number of smaller blocks (more than 30, typically from 50 to 500), in which case these blocks preferably have relatively low weights/masses, for example from 500 to 5000 g/mol; these thermoplastic elastomers will subsequently be referred to as multiblock thermoplastic elastomers.

The thermoplastic elastomers which can be used according to the invention can be provided in a linear form.

The thermoplastic elastomers can in particular be diblock copolymers: thermoplastic block/elastomer block. They can also be triblock copolymers: thermoplastic block/elastomer block/thermoplastic block, that is to say a central elastomer block and a terminal thermoplastic block at each of the two ends of the elastomer block. Also suitable as thermoplastic elastomers are the mixtures of triblock copolymers and of diblock copolymers described in the present document. This is because the triblock copolymers can contain a minor fraction by weight of diblock copolymer consisting of a rigid styrene segment and of a flexible diene segment, the rigid block and the flexible block being respectively of the same chemical nature, in particular of the same microstructure, as the rigid and flexible blocks of the triblock. The presence of diblock copolymer in the triblock copolymer generally results from the process for the synthesis of the triblock copolymer, which can result in the formation of by-product, such as the diblock copolymer. Generally, the percentage of diblock copolymer in the triblock copolymer does not exceed 40% by weight of triblock copolymer.

The thermoplastic elastomers can also be formed of a linear sequence of elastomer blocks and of thermoplastic blocks (multiblock thermoplastic elastomers).

According to a second alternative form, the thermoplastic elastomers which can be used according to the invention are provided in a star-branched form comprising at least three branches.

For example, the thermoplastic elastomers can then be composed of a star-branched elastomer block comprising at least three branches and of a thermoplastic block located at the end of each of the branches of the elastomer block. The number of branches of the central elastomer can vary, for example, from 3 to 12 and preferably from 3 to 6.

According to a third alternative form, the thermoplastic elastomers which can be used according to the invention are provided in a branched or dendrimer form. The thermoplastic elastomers can then be composed of a branched or dendrimer elastomer block and of a thermoplastic block located at the end of the branches of the dendrimer elastomer block.

As indicated above, the thermoplastic elastomer(s) which can be used according to the invention comprise at least one elastomer block and at least one thermoplastic block, the elastomer block(s) not denoting one or more polyisobutylene blocks.

“Polyisobutylene block” should be understood as meaning, within the meaning of the present invention, a block predominantly composed of the polymerized isobutylene monomer.

The elastomer blocks of the thermoplastic elastomers which can be used according to the invention can be all the elastomers known to a person skilled in the art, with the exception of the thermoplastic elastomers for which the elastomer block(s) denote one or more polyisobutylene blocks.

A distinction is generally made between saturated elastomer blocks and unsaturated elastomer blocks.

Saturated elastomer block is understood to mean that this block essentially comprises units not comprising ethylenic unsaturations (that is to say, carbon-carbon double bonds), that is to say that the units comprising ethylenic unsaturations represent less than 15 mol %, with respect to all of the units of the block under consideration.

The saturated elastomer blocks are generally formed by the polymerization of ethylenic monomers. Mention may in particular be made of polyalkylene blocks, with the exception of polyisobutylene blocks, such as random ethylene/propylene or ethylene/butylene copolymers. These saturated elastomer blocks can also be obtained by hydrogenation of unsaturated elastomer blocks.

They can also be aliphatic blocks resulting from the families of the polyethers, polyesters or polycarbonates. In particular, the saturated elastomer blocks can especially be formed by polyethers, especially polytetramethylene glycols (PTMGs) or polyethylene glycols (PEGs).

According to an alternative form, the monomers polymerized in order to form a saturated elastomer block can be randomly copolymerized with at least one other monomer so as to form a saturated elastomer block. According to this alternative form, the molar fraction of polymerized monomer, other than an ethylenic monomer, with respect to the total number of units of the saturated elastomer block, has to be such that this block retains its saturated elastomer properties. Advantageously, the molar fraction of this other comonomer can range from 0% to 50%, more preferentially from 0% to 45% and more preferentially still from 0% to 40%.

For example, conjugated C₄-C₁₄ dienes can be copolymerized with the ethylenic monomers, the ethylenic units remaining predominant, as seen above.

Preferably, these conjugated dienes are chosen from isoprene, butadiene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 1,3-hexadiene, 2-methyl-1,3-hexadiene, 3-methyl-1,3-hexadiene, 4-methyl-1,3-hexadiene, 5-methyl-1,3-hexadiene, 2,3-dimethyl-1,3-hexadiene, 2,4-dimethyl-1,3-hexadiene, 2,5-dimethyl-1,3-hexadiene, 2-neopentylbutadiene, 1,3-cyclopentadiene, 1,3-cyclohexadiene, 1-vinyl-1,3-cyclohexadiene and a mixture of these conjugated dienes, and preferably these conjugated dienes are chosen from isoprene and a mixture of conjugated dienes containing isoprene.

Unsaturated elastomer block is understood to mean that this block results, at least in part, from conjugated diene monomers, having a content of units of diene origin (conjugated dienes) which is greater than 15 mol %.

When the elastomer blocks of the thermoplastic elastomers which can be used according to the invention are unsaturated, they can be chosen from:
a) any homopolymer obtained by polymerization of a conjugated diene monomer having from 4 to 12 carbon atoms;
b) any copolymer obtained by copolymerization of one or more conjugated dienes with one another or with one or more vinylaromatic compounds having from 8 to 20 carbon atoms;
c) a ternary copolymer obtained by copolymerization of ethylene and of an α-olefin having from 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, in particular, 1,4-hexadiene, ethylidenenorbornene or dicyclopentadiene;
d) a copolymer of isobutene and of isoprene (diene butyl rubber) and also the halogenated versions, in particular chlorinated or brominated versions, of this type of copolymer.

The following are suitable in particular as conjugated dines: isoprene, 1,3-butadiene, piperylene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 2,5-dimethyl-1,3-pentadiene, 2-methyl-1,4-pentadiene, 1,3-hexadiene, 2-methyl-1,3-hexadiene, 2-methyl-1,5-hexadiene, 3-methyl-1,3-hexadiene, 4-methyl-1,3-hexadiene, 5-methyl-1,3-hexadiene, 2,5-dimethyl-1,3-hexadiene, 2,5-dimethyl-2,4-hexadiene, 2-neopentyl-1,3-butadiene, 1.3-cyclopentadiene, methylcyclopentadiene, 2-methyl-1,6-heptadiene, 1,3-cyclohexadiene, 1-vinyl-1,3-cyclohexadiene and a mixture of these conjugated dienes; preferably, these conjugated dienes are chosen from isoprene, butadiene and a mixture containing isoprene and/or butadiene.

According to an alternative form, the monomers polymerized in order to form an unsaturated elastomer block can be randomly copolymerized with at least one other monomer so as to form an unsaturated elastomer block. According to this alternative form, the molar fraction of polymerized monomer other than a diene monomer, with respect to the total number of units of the unsaturated elastomer block, has to be such that this block retains its unsaturated elastomer properties. Advantageously, the molar fraction of this other comonomer can range from 0% to 50%, more preferentially from 0% to 45% and more preferentially still from 0% to 40%.

By way of illustration, this other monomer capable of copolymerizing with the first monomer can be chosen from ethylenic monomers, such as ethylene, propylene or butylene, monomers of vinylaromatic type having from 8 to 20 carbon atoms as defined below, or else it can be a monomer such as vinyl acetate.

Styrene monomers, namely methylstyrenes, para-(tert-butyl)styrene, chlorostyrenes, bromostyrenes, fluorostyrenes or also para-hydroxystyrene, are suitable in particular as vinylaromatic compounds. Preferably, the comonomer of vinylaromatic type is styrene.

Thus, according to a preferential embodiment, the at least one elastomer block can be a random copolymer of styrene/butadiene (SBR) type, it being possible for this copolymer to be partially hydrogenated. This SBR block preferably has a Tg (glass transition temperature), measured by DSC according to Standard ASTM D3418 of 1999, of less than −50° C. In a well-known way, the SBR block comprises a styrene content, a content of 1,2-bonds of the butadiene part and a content of 1,4-bonds of the butadiene part, the latter being composed of a content of trans-1,4-bonds and of a content of cis-1,4-bonds when the butadiene part is not hydrogenated. Preferentially, use is made in particular of an SBR block having a styrene content, for example, within a range extending from 10% to 60% by weight, preferably from 20% to 50% by weight, and, for the butadiene part, a content of 1,2-bonds within a range extending from 4% to 75% (mol %) and a content of 1,4-bonds within a range extending from 20% to 96% (mol %).

The degree of hydrogenation is determined by an NMR analysis. The spectra are acquired on a Bruker Avance 500 MHz spectrometer equipped with a 5 mm 1H-X Cryoprobe. The quantitative ¹H NMR experiment uses a simple 30° pulse sequence and a repetition time of 5 seconds between each acquisition. 64 accumulations are carried out. The samples (approximately 25 mg) are dissolved in approximately 1 ml of CS₂; 100 μl of deuterated cyclohexane are added to form the lock during the acquisition. The chemical shifts are calibrated with respect to the protonated impurity of the CS₂ ¹H δ ppm at 7.18 ppm, with reference to TMS (¹H δ ppm at 0 ppm). The ¹H NMR spectrum makes it possible to quantify the microstructure by integration of the broad unresolved peaks of signals characteristic of the different units:
The styrene originating from the polystyrene blocks and SBR. It is quantifiable in the aromatics region between 6.0 ppm and 7.3 ppm for 5 protons (with subtraction of the integral of the signal of the CS₂ impurity at 7.18 ppm).
The 1,2-PB originating from the SBR. It is quantifiable in the ethylenic region between 4.6 ppm and 5.1 ppm for 2 protons.
The 1,4-PB originating from the SBR. It is quantifiable in the ethylenic region between 5.1 ppm and 6.1 ppm for 2 protons and with deletion of 1 proton of the 1,2-PB unit.
The hydrogenated 1,2-PB originating from the hydrogenation and only exhibiting aliphatic protons. The pendent CH₃ groups of the hydrogenated 1,2-PB were identified and are quantifiable in the aliphatic region between 0.4 and 0.8 ppm for 3 protons.
The hydrogenated 1,4-PB originating from the hydrogenation and only exhibiting aliphatic protons. It will be deduced by subtracting the aliphatic protons of the various units, considering it for 8 protons.

The microstructure can be quantified in mol % as follows: mol % of a unit=¹H integral of a unit/Σ(¹H integrals of each unit). For example, for a styrene unit: mol % of styrene=(¹H integral of styrene)/(¹H integral of styrene+¹H integral of 1,2-PB+¹H integral of 1,4-PB+¹H integral of hydrogenated 1,2-PB+¹H integral of hydrogenated 1,4-PB).

Preferably, in the thermoplastic elastomers of use for the requirements of the invention, the SBR elastomer block is hydrogenated in such a way that a proportion ranging from 10 mol % to 50 mol % of the double bonds in the butadiene portion are hydrogenated.

Preferably for the invention, the elastomer blocks of the thermoplastic elastomers exhibit a number-average molecular weight (Mn) ranging from 25 000 g/mol to 350 000 g/mol, preferably from 35 000 g/mol to 250 000 g/mol, so as to confer, on the thermoplastic elastomers, good elastomeric properties and a mechanical strength which is sufficient and compatible with the use as tyre external sidewall.

Particularly preferably in the invention, the elastomer block(s) of the thermoplastic elastomer are selected from the group consisting of polyisoprenes, polybutadienes, copolymers of styrene and of butadiene, and the mixtures of these elastomers, these elastomers being non-hydrogenated or partially hydrogenated.

As explained above, the thermoplastic elastomers which can be used according to the invention comprise at least one thermoplastic block.

Thermoplastic block is understood to mean a block formed of polymerized monomers and having a glass transition temperature, or a melting point in the case of semicrystalline polymers, of greater than or equal to 80° C., preferably varying from 80° C. to 250° C., more preferentially varying from 80° C. to 200° C. and in particular varying from 80° C. to 180° C.

This is because, in the case of a semicrystalline polymer, a melting point greater than the glass transition temperature may be observed. In this case, the melting point and not the glass transition temperature is taken into account for the above definition.

The thermoplastic block(s) can be formed from polymerized monomers of various natures.

In particular, the thermoplastic block(s) of the thermoplastic elastomer can be selected from the group consisting of polyolefins (preferably polyethylene, polypropylene or a mixture thereof), polyurethanes, polyamides, polyesters, polyacetals, polyethers (preferably polyethylene oxide, polyphenylene ether or a mixture thereof), polyphenylene sulfides, polyfluorinated compounds (preferably FEP, PFA, ETFE or mixtures thereof), polystyrenes, polycarbonates, polysulfones, poly(methyl methacrylate), polyetherimide, thermoplastic copolymers (such as the acrylonitrile/butadiene/styrene (ABS) copolymer) and the mixtures of these polymers.

Particularly preferably in the invention, the thermoplastic block(s) of the thermoplastic elastomer are selected from the group consisting of polystyrenes, polyesters, polyamides, polyurethanes and the mixtures of these polymers.

Very particularly preferably in the invention, the thermoplastic block(s) are selected from the group consisting of polystyrenes, polyesters, polyamides and the mixtures of these polymers.

The thermoplastic block(s) can also be obtained from the monomers chosen from:
acenaphthylene: a person skilled in the art may refer, for example, to the paper by Z. Fodor and J. P. Kennedy, Polymer Bulletin, 1992, 29(6), 697-705;
indene and its derivatives, such as, for example, 2-methylindene, 3-methylindene, 4-methylindene, dimethylindenes, 2-phenylindene, 3-phenylindene and 4-phenylindene; a person skilled in the art may, for example, refer to the patent document U.S. Pat. No. 4,946,899, by the inventors Kennedy, Puskas, Kaszas and Hager, and to the documents by J. E. Puskas, G. Kaszas, J. P. Kennedy and W. G. Hager, Journal of Polymer Science, Part A: Polymer Chemistry (1992), 30, 41, and J. P. Kennedy, N. Meguriya and B. Keszler, Macromolecules (1991), 24(25), 6572-6577;
isoprene, then resulting in the formation of a certain number of trans-1,4-polyisoprene units and of units cyclized according to an intramolecular process; a person skilled in the art may, for example, refer to the documents by G. Kaszas, J. E. Puskas and J. P. Kennedy, Applied Polymer Science (1990), 39(1), 119-144, and J. E. Puskas, G. Kaszas and J. P. Kennedy, Macromolecular Science, Chemistry A28 (1991), 65-80.

According to an alternative form of the invention, the above monomers can be copolymerized with at least one other monomer as long as the latter does not modify the thermoplastic nature of the block, that is to say that the block has a glass transition temperature, or a melting point in the case of semi-crystalline polymers, of greater than or equal to 80° C.

By way of illustration, this other monomer capable of copolymerizing with the polymerized monomer can be chosen from diene monomers, more particularly conjugated diene monomers having from 4 to 14 carbon atoms, and monomers of vinylaromatic type having from 8 to 20 carbon atoms, as are defined in the part relating to the elastomer block.

The thermoplastic block(s) can be chosen from polystyrenes and polymers comprising at least one polystyrene block.

As regards the polystyrenes, the latter are obtained from styrene monomers.

Styrene monomer should be understood as meaning, in the present description, any monomer comprising styrene, both unsubstituted or substituted; mention may be made, among substituted styrenes, for example, of methylstyrenes (for example, o-methylstyrene, m-methylstyrene or p-methylstyrene, α-methylstyrene, α,2-dimethylstyrene, α,4-dimethylstyrene or diphenylethylene), para-(tert-butyl)styrene, chlorostyrenes (for example, o-chlorostyrene, m-chlorostyrene, p-chlorostyrene, 2,4-dichlorostyrene, 2,6-dichlorostyrene or 2,4,6-trichlorostyrene), bromostyrenes (for example, o-bromostyrene, m-bromostyrene, p-bromostyrene, 2,4-dibromostyrene, 2,6-dibromostyrene or 2,4,6-tribromostyrene), fluorostyrenes (for example, o-fluorostyrene, m-fluorostyrene, p-fluorostyrene, 2,4-difluorostyrene, 2,6-difluorostyrene or 2,4,6-trifluorostyrene) or else para-hydroxystyrene.

According to a preferential embodiment of the invention, the content by weight of styrene in the thermoplastic elastomers which can be used according to the invention is between 5% and 50%, preferentially between 10% and 40%.

The proportion of thermoplastic blocks in the thermoplastic elastomers which can be used according to the invention is determined, on the one hand, by the thermoplasticity properties which the thermoplastic elastomers should exhibit.

The thermoplastic block(s) are preferentially present in sufficient proportions to preserve the thermoplastic nature of the thermoplastic elastomers which can be used according to the invention. The minimum content of thermoplastic blocks in the thermoplastic elastomers can vary as a function of the conditions of use of the thermoplastic elastomers.

On the other hand, the ability of the thermoplastic elastomers to deform during the preparation of the tyre can also contribute to determining the proportion of the thermoplastic blocks in the thermoplastic elastomers which can be used according to the invention.

Preferably, the thermoplastic blocks of the thermoplastic elastomers exhibit a number-average molecular weight (Mn) ranging from 5000 g/mol to 150 000 g/mol, so as to confer, on the thermoplastic elastomers, good elastomeric properties and a mechanical strength which is sufficient and compatible with the use as tyre external sidewall.

According to the invention, the thermoplastic elastomer(s) can be selected from the group consisting of styrene/butadiene (SB), styrene/isoprene (SI), styrene/butadiene/isoprene (SBI), styrene/butadiene/isoprene/styrene (SBIS), styrene/butadiene/styrene (SBS), styrene/isoprene/styrene (SIS) and styrene/optionally partially hydrogenated butadiene-styrene copolymer/styrene (SOE) block copolymers and the mixtures of these copolymers.

Preferably in the invention, the thermoplastic elastomer(s) are selected from the group consisting of styrene/butadiene/styrene (SBS), styrene/isoprene/styrene (SIS) and styrene/optionally partially hydrogenated butadiene-styrene copolymer/styrene (SOE) block copolymers and the mixtures of these copolymers.

Preferably again, the thermoplastic elastomer(s) are selected from the group consisting of styrene/butadiene/styrene (SBS) and styrene/optionally partially hydrogenated butadiene-styrene copolymer/styrene (SOE) block copolymers and the mixtures of these copolymers.

Particularly advantageously, the styrene/optionally partially hydrogenated butadiene-styrene copolymer/styrene (SOE) block copolymers are styrene/partially hydrogenated butadiene-styrene copolymer/styrene (SOE) block copolymers. Preferably, the styrene/partially hydrogenated butadiene-styrene copolymer/styrene block copolymers exhibit a molar degree of hydrogenation within a range extending from 30% to 98%, preferably from 50% to 98%, more preferably from 85% to 97%.

Mention may be made, by way of examples of commercially available thermoplastic elastomers which can be used according to the invention, of the elastomers of SIS type sold by Kuraray under the name Hybrar 5125 or sold by Kraton under the name D 1161, or also of the elastomers of linear SBS type sold by Polimeri Europa under the name Europrene SOL T 166 or of star-branched SBS type sold by Kraton under the name D1184. Mention may also be made of the elastomers sold by Dexco Polymers under the name Vector (for example, Vector 4114 or Vector 8508).

Preferably, the content of thermoplastic elastomer(s) comprising at least one elastomer block and at least one thermoplastic block, the elastomer block(s) not denoting one or more polyisobutylene block(s), in the composition is within a range extending from 1 to 50 phr, preferably from 5 to 45 phr, more preferentially from 10 to 40 phr, more preferentially still from 15 to 35 phr.

Particularly preferably, the thermoplastic elastomer(s) comprising at least one elastomer block and at least one thermoplastic block, the elastomer(s) not denoting one or more polyisobutylene block(s), are the only thermoplastic elastomers of the elastomeric matrix.

II-1-c Other Elastomers

The elastomeric matrix of the composition of the external sidewall which can be used according to the invention can comprise diene or thermoplastic elastomers other than the diene elastomer selected from the group consisting of butadiene polymers having a glass transition temperature of less than or equal to −50° C., and the thermoplastic elastomer comprising at least one elastomer block and at least one thermoplastic block, the thermoplastic elastomer not comprising a polyisobutylene block, but this is not obligatory or even preferable.

Advantageously, the composition of the external sidewall which can be used according to the invention does not comprise another elastomer than the diene elastomer selected from the group consisting of butadiene polymers having a glass transition temperature of less than or equal to −50° C., and the thermoplastic elastomer comprising at least one elastomer block and at least one thermoplastic block, the thermoplastic elastomer not comprising a polyisobutylene block, or comprises less than 20 phr, preferably less than 10 phr, more preferably less than 10 phr, thereof.

II-2 Antiozone Wax

The composition of the external sidewall of the tyre according to the present invention also has the essential feature of not comprising antiozone wax or of comprising less than 1 phr thereof, that is to say strictly less than 1 (i.e. less than 1.0 phr), preferably less than 0.95 phr, preferably less than 0.90 phr.

The antiozone waxes are well known to a person skilled in the art. The antiozone wax which can be used in the context of the present invention can be, in particular, a natural wax, a synthetic wax or a mixture of natural wax and synthetic wax. For example, the antiozone wax can be a natural wax selected from the group consisting of mineral waxes (preferably paraffin waxes), vegetable waxes, animal waxes, and mixtures thereof. The antiozone wax can also be a synthetic wax selected from the group consisting of Fischer-Tropsch waxes, polyethylene waxes and mixtures thereof.

Advantageously, the antiozone wax is selected from the group consisting of paraffin waxes, Fischer-Tropsch waxes and mixtures thereof. Preferably, the antiozone wax is a paraffin wax or a mixture of paraffin waxes.

Advantageously, the antiozone wax comprises predominantly, and advantageously consists of, linear or branched hydrocarbon chains, the number of carbon atoms of which is within a range extending from 18 to 70, preferably from 18 to 65, more preferably from 18 to 60, preferably from 18 to 55, preferably from 18 to 50, preferably from 20 to 40, preferably from 22 to 38. Preferably, the hydrocarbon chains of the antiozone wax are essentially saturated. Within the context of the present invention, the term “essentially saturated” is understood to mean a content of diene unit of less than 15%, preferably less than 10%, preferably less than 5%, for example 0%.

The ratio of branched (iso)/unbranched (normal) hydrocarbon chains in the antiozone wax can be within a range extending from 0/100 to 80/20, preferably from 5/95 to 65/35. Advantageously, the ratio of branched (iso)/unbranched (normal) hydrocarbon chains in the antiozone wax can be within a range extending from 5/95 to 35/65, even more preferentially from 5/95 to 20/80. Also advantageously, the ratio of branched (iso)/unbranched (normal) hydrocarbon chains in the antiozone wax can be within a range extending from 35/65 to 65/35, preferably from 40/60 to 60/40.

Advantageously, the composition of the external sidewall of the tyre according to the invention does not comprise antiozone wax, that is to say that the content of antiozone wax in the said composition is 0 phr.

Alternatively, and also advantageously, the content of antiozone wax in the composition of the external sidewall of the tyre according to the invention can be within a range extending from 0.1 to 0.9 phr, preferably from 0.2 to 0.8 phr, more preferably from 0.3 to 0.7 phr.

Such antiozone waxes can be natural waxes such as for example Candelilla wax or Carnauba wax. By way of example of commercially available antiozone wax, mention may be made of Redezon waxes (for example the 500, PWM-80, 7335-G, 7812 series) from Repsol, Varazon waxes (for example the 5998, 4959, 6500, 6810 series) from Sasol, Ozoace 0355 wax from Nippon Seiro, OK2122 or OK5258H wax from Paramelt Co., Ltd., Negozone 9343 wax from H&R or else H3841 wax from Yanggu Huatai.

II-3 Reinforcing Filler

The composition of the external sidewall of the tyre according to the invention additionally comprises a reinforcing filler, known for its abilities to reinforce a rubber composition which can be used for the manufacture of tyres.

The reinforcing filler can comprise carbon black and/or silica. Advantageously, the reinforcing filler predominantly, preferably exclusively, comprises carbon black.

The blacks which can be used in the context of the present invention can be any black conventionally used in tyres or their treads (“tyre-grade” blacks). Among the latter, mention will more particularly be made of the reinforcing carbon blacks of the 100, 200 and 300 series, or the blacks of the 500, 600 or 700 series (ASTM grades), such as, for example, the N115, N134, N234, N326, N330, N339, N347, N375, N550, N683 and N772 blacks. These carbon blacks can be used in the isolated state, as available commercially, or in any other form, for example as support for some of the rubber additives used. The carbon blacks might, for example, be already incorporated in the diene elastomer, in particular isoprene elastomer, in the form of a masterbatch (see, for example, Applications WO 97/36724 or WO 99/16600).

Mention may be made, as examples of organic fillers other than carbon blacks, of functionalized polyvinyl organic fillers, such as described in Applications WO 2006/069792, WO 2006/069793, WO 2008/003434 and WO 2008/003435.

Advantageously, the carbon black predominantly, preferably exclusively, comprises a carbon black exhibiting a BET specific surface of less than 70 m²/g (preferably within a range extending from 11 to 69 m²/g), preferably of less than 50 m²/g, preferably a BET specific surface within a range extending from 11 to 49 m²/g, more preferably from 21 to 49 m²/g.

The BET specific surface of the carbon blacks is measured according to Standard D6556-10 [multipoint (a minimum of 5 points) method—gas: nitrogen—relative pressure p/pₒ range: 0.1 to 0.3].

The silicas which can be used in the context of the present invention can be any silica known to a person skilled in the art, in particular any precipitated or fumed silica exhibiting a BET specific surface and a CTAB specific surface which are both less than 450 m²/g, preferably from 30 to 400 m²/g.

The BET specific surface of the silica is determined in a known way by gas adsorption using the Brunauer-Emmett-Teller method described in The Journal of the American Chemical Society, Vol. 60, page 309, February 1938, more specifically according to French Standard NF ISO 9277 of December 1996 (multipoint (5 point) volumetric method—gas: nitrogen—degassing: 1 hour at 160° C.—relative pressure p/pₒ range: 0.05 to 0.17). The CTAB specific surface of the silica is determined according to French Standard NF T 45-007 of November 1987 (method B).

Preferably, the silica exhibits a BET specific surface of less than 200 m²/g and/or a CTAB specific surface of less than 220 m²/g, preferably a BET specific surface within a range extending from 125 to 200 m²/g and/or a CTAB specific surface within a range extending from 140 to 170 m²/g.

Mention will be made, as silicas which can be used in the context of the present invention, for example, of the highly dispersible precipitated silicas (termed “HDSs”) Ultrasil 7000 and Ultrasil 7005 from Evonik, the Zeosil 1165MP, 1135MP and 1115MP silicas from Rhodia, the Hi-Sil EZ150G silica from PPG, the Zeopol 8715, 8745 and 8755 silicas from Huber or the silicas with a high specific surface as described in Application WO 03/16837.

In order to couple the reinforcing silica to the diene elastomer, use is made, in a well-known way, of an at least bifunctional coupling agent (or bonding agent) intended to provide a satisfactory connection, of chemical and/or physical nature, between the silica (surface of its particles) and the diene elastomer. Use is made in particular of organosilanes or polyorganosiloxanes which are at least bifunctional.

A person skilled in the art can find coupling agent examples in the following documents: WO 02/083782, WO 02/30939, WO 02/31041, WO 2007/061550, WO 2006/125532, WO 2006/125533, WO 2006/125534, U.S. Pat. No. 6,849,754, WO 99/09036, WO 2006/023815, WO 2007/098080, WO 2010/072685 and WO 2008/055986.

Mention may in particular be made of alkoxysilane polysulfide compounds, especially bis(trialkoxysilylpropyl) polysulfides, very particularly bis(3-triethoxysilylpropyl) disulfide (abbreviated to “TESPD”) and bis(3-triethoxysilylpropyl) tetrasulfide (abbreviated to “TESPT”). It should be remembered that TESPD, of formula [(C₂H₅O)₃Si(CH₂)₃S]₂, is in particular sold by Degussa under the name Si266 or Si75 (in the second case, in the form of a mixture of disulfide (at 75% by weight) and of polysulfides). TESPT, of formula [(C₂H₅O)₃Si(CH₂)₃S]₄, is sold in particular by Degussa under the name Si69 (or X50S when it is supported at 50% by weight on carbon black), in the form of a commercial mixture of polysulfides Sₓ with a mean value for x which is approximately 4.

The content of reinforcing filler in the composition is preferably within a range extending from 5 to 70 phr, preferably from 5 to 55 phr, more preferably from 5 to 45 phr.

II-4 Crosslinking System

The system for crosslinking the composition of the external sidewall of the tyre according to the invention can be based on molecular sulfur and/or on sulfur donors and/or on peroxide, which are well known to a person skilled in the art.

The crosslinking system is preferentially a vulcanization system based on sulfur (molecular sulfur and/or sulfur-donating agent).

The sulfur is used at a preferential content of between 0.5 and 10 phr. Advantageously, the content of sulfur is between 0.5 and 2 phr, preferably between 0.5 and 1.5 phr and more preferably between 0.5 and 1.4 phr.

The composition of the external sidewall of the tyre according to the invention advantageously comprises a vulcanization accelerator, which is preferably selected from the group consisting of accelerators of the type of the thiazoles and their derivatives, accelerators of the types of the sulfenamides and thioureas and of their mixtures. Advantageously, the vulcanization accelerator is selected from the group consisting of 2-mercaptobenzothiazyl disulfide (MBTS), N-cyclohexyl-2-benzothiazolesulfenamide (CBS), N,N-dicyclohexyl-2-benzothiazolesulfenamide (DCBS), N-(tert-butyl)-2-benzothiazolesulfenamide (TBBS), N-(tert-butyl)-2-benzothiazolesulfenimide (TBSI), morpholine disulfide, N-morpholino-2-benzothiazolesulfenamide (MBS), dibutylthiourea (DBTU) and of their mixtures. Particularly preferably, the primary vulcanization accelerator is N-cyclohexyl-2-benzothiazolesulfenamide (CBS).

The content of vulcanization accelerator is preferentially within a range extending from 0.2 to 10 phr, preferably from 0.2 to 7 phr, more preferably from 0.6 to 2 phr.

Advantageously, the sulfur or sulfur donor/vulcanization accelerator ratio by weight varies from 0.8 to 1.2.

II-5 Plasticizers

According to a preferential embodiment of the invention, the composition used in the external sidewall of the tyre according to the invention can also comprise at least one plasticizing agent, such as an oil (or plasticizing oil or extender oil) or a plasticizing resin, the role of which is to facilitate the processing of the external sidewall, particularly its incorporation in the pneumatic object, by a lowering of the modulus and an increase in the tackifying power.

Use may be made of any type of plasticizer which can be a plasticizing resin or a plasticizing oil. The designation “resin” is reserved in the present patent application, by definition known to a person skilled in the art, for a compound which is solid at ambient temperature (23° C.), in contrast to a liquid plasticizing compound, such as an extender oil or a plasticizing oil. At ambient temperature (23° C.), these oils, which are more or less viscous, are liquids (that is to say, as a reminder, substances which have the ability to eventually take on the shape of their container), as opposed in particular to resins or rubbers, which are by nature solids.

Preferably, the plasticizing oil is selected from the group consisting of naphthenic oils (having a low or high viscosity, in particular hydrogenated or non-hydrogenated), paraffinic oils, MES (Medium Extracted Solvates) oils, TDAE (Treated Distillate Aromatic Extracts) oils, RAE (Residual Aromatic Extracts) oils, TRAE (Treated Residual Aromatic Extracts) oils and SRAE (Safety Residual Aromatic Extracts) oils, mineral oils, vegetable oils, ether plasticizers, ester plasticizers, phosphate plasticizers, sulfonate plasticizers, liquid polymers and their mixtures. Preferably, the plasticizing oil is selected from the group consisting of naphthenic oils, paraffinic oils, MES oils, TDAE oils, RAE oils, TRAE oils and SRAE oils, mineral oils, liquid polymers and their mixtures, preferably from the group consisting of naphthenic oils, paraffinic oils, MES oils, TDAE oils, RAE oils, TRAE oils and SRAE oils, mineral oils and their mixtures.

The-number-average molecular weight (Mn) of the plasticizing oil is preferentially between 200 and 25 000 g/mol, more preferentially still between 300 and 10 000 g/mol. For excessively low Mn weights, there exists a risk of the oil migrating outside the composition, whereas excessively high weights can result in excessive stiffening of this composition. An Mn weight of between 350 and 4000 g/mol, in particular between 400 and 3000 g/mol, has proved to constitute an excellent compromise for the targeted applications, in particular for use in a tyre external sidewall.

The number-average molecular weight (Mn) of the plasticizing oil is determined by size exclusion chromatography (SEC), the sample being dissolved beforehand in tetrahydrofuran at a concentration of approximately 1 g/l; the solution is then filtered through a filter with a porosity of 0.45 μm before injection. The apparatus is the Waters Alliance chromatographic line. The elution solvent is tetrahydrofuran, the flow rate is 1 ml/min, the temperature of the system is 35° C. and the analytical time is 30 min. A set of two Waters columns with the Styragel HT6E name is used. The injected volume of the solution of the polymer sample is 100 μl. The detector is a Waters 2410 differential refractometer and its associated software, for making use of the chromatographic data, is the Waters Millennium system. The calculated average molar masses are relative to a calibration curve produced with polystyrene standards.

Mention may be made, as examples of plasticizing oils which can be used in the context of the present invention, of the MES oil, Catenex SNR, from Shell (Tg of −65° C.) or also of the TDAE oil, Vivatec 500, from Klaus Dahleke (Tg of −48° C.).

Hydrocarbon resins are polymers well known to a person skilled in the art, essentially based on carbon and hydrogen, which can be used in particular as plasticizing agents in elastomeric compositions. They have been described, for example, in the work entitled “Hydrocarbon Resins” by R. Mildenberg, M Zander and G. Collin (New York, VCH, 1997, ISBN 3-527-28617-9), Chapter 5 of which is devoted to their applications, in particular in the tyre rubber field (5.5. “Rubber Tires and Mechanical Goods”). They can be aliphatic, cycloaliphatic, aromatic, hydrogenated aromatic, of the aliphatic/aromatic type, that is to say based on aliphatic and/or aromatic monomers. They can be natural or synthetic and based or not based on petroleum (if such is the case, they are also known under the name of petroleum resins). They are by definition miscible (i.e., compatible) at the contents used with the elastomeric compositions for which they are intended, so as to act as true diluents. Their Tg is preferably greater than 0° C., in particular greater than 20° C. (most often between 30° C. and 120° C.

In a known way, these hydrocarbon resins can also be described as thermoplastic resins in the sense that they soften when heated and can thus be moulded. They can also be defined by a softening point, the temperature at which the product, for example in the powder form, sticks together. The softening point of a hydrocarbon resin is generally greater by approximately 50 to 60° C. than its Tg value.

Mention may be made, as examples of such hydrocarbon resins, of those selected from the group consisting of cyclopentadiene (abbreviated to CPD) or dicyclopentadiene (abbreviated to DCPD) homopolymer or copolymer resins, terpene homopolymer or copolymer resins, terpene/phenol homopolymer or copolymer resins, C₅ fraction homopolymer or copolymer resins, C₉ fraction homopolymer or copolymer resins, α-methylstyrene homopolymer or copolymer resins and the mixtures of these resins. Mention may more particularly be made, among the above copolymer resins, of those selected from the group consisting of (D)CPD/vinylaromatic copolymer resins, (D)CPD/terpene copolymer resins, (D)CPD/C₅ fraction copolymer resins, (D)CPD/C₅ fraction copolymer resins, (D)CPD/C₉ fraction copolymer resins, terpene/vinylaromatic copolymer resins, terpene/phenol copolymer resins, C₅ fraction/vinylaromatic copolymer resins and the mixtures of these resins.

The term “terpene” groups together here, in a known way, α-pinene, β-pinene and limonene monomers; use is preferentially made of a limonene monomer, a compound which exists, in a known way, in the form of three possible isomers: L-limonene (laevorotatory enantiomer), D-limonene (dextrorotatory enantiomer) or else dipentene, a racemate of the dextrorotatory and laevorotatory enantiomers. Suitable as vinylaromatic monomer are, for example, styrene, α-methylstyrene, ortho-methylstyrene, meta-methylstyrene, para-methylstyrene, vinyltoluene, para-(tert-butyl)styrene, methoxystyrenes, chlorostyrenes, hydroxystyrenes, vinylmesitylene, divinylbenzene, vinylnaphthalene or any vinylaromatic monomer resulting from a C₉ fraction (or more generally from a C₈ to C₁₀ fraction).

More particularly, mention may be made of the resins selected from the group consisting of (D)CPD homopolymer resins, (D)CPD/styrene copolymers resins, polylimonene resins, limonene/styrene copolymer resins, limonene/(D)CPD copolymer resins, C₅ fraction/styrene copolymers resins, C₅ fraction/C₉ fraction copolymer resins and the mixtures of these resins.

All the above resins are well known to a person skilled in the art and are commercially available, for example sold by DRT under the name Dercolyte as regards polylimonene resins, by Neville Chemical Company under the name Super Nevtac, by Kolon under the name Hikorez or by Exxon Mobil under the name Escorez as regards C₅ fraction/styrene resins or C₅ fraction/C₉ fraction resins, or by Struktol under the name 40 MS or 40 NS (mixtures of aromatic and/or aliphatic resins).

When it is used, it is preferable for the content of plasticizer in the composition of the external sidewall of the tyre according to the invention to be within a range extending from 2 to 60 phr, preferentially from 3 to 50 phr and more preferentially still from 3 to 20 phr. Below the minimum indicated, the presence of plasticizer is not noticeable. Above the maximum recommended, there is a risk of insufficient cohesion of the composition.

Advantageously, the plasticizer predominantly, preferably exclusively, comprises at least one plasticizing oil. Advantageously, the content of plasticizing oil in the composition of the external sidewall of the tyre according to the invention is within a range extending from 2 to 60 phr, preferentially from 3 to 50 phr and more preferentially still from 3 to 20 phr.

II-6 Various Additives

The rubber compositions of the external sidewall of the tyre according to the invention can also comprise all or part of the usual additives known to a person skilled in the art and generally used in rubber compositions for tyres, in particular external sidewall compositions, such as, for example, plasticizers other than those mentioned above (such as plasticizing resins), fillers (other than those mentioned above), pigments, protective agents, such as antiozone waxes, chemical antiozonants or antioxidants, or anti-fatigue agents.

II-7 Preparation of the Rubber Compositions

The rubber composition in accordance with the invention is manufactured in appropriate mixers using two successive preparation phases well known to a person skilled in the art:
a first phase of thermomechanical working or kneading (“non-productive” phase), which can be carried out in a single thermomechanical stage during which all the necessary constituents, in particular the elastomeric matrix, the fillers, the plasticizers and the optional other various additives, with the exception of the crosslinking system, are introduced into an appropriate mixer, such as a standard internal mixer (for example of ‘Banbury’ type). The incorporation of the filler in the elastomer can be carried out in one or more goes by thermomechanically kneading. In the case where the filler, in particular the carbon black, is already incorporated, in all or in part, in the elastomer in the form of a masterbatch, as is described, for example, in Applications WO 97/36724 and WO 99/16600, it is the masterbatch which is directly kneaded and, if appropriate, the other elastomers or fillers present in the composition which are not in the masterbatch form, and also the optional other various additives other than the crosslinking system, are incorporated.
The non-productive phase is carried out at high temperature, up to a maximum temperature of between 110° C. and 200° C., preferably between 130° C. and 185° C., for a period of time generally of between 2 and 10 minutes.
a second phase of mechanical working (“productive” phase), which is carried out in an external mixer, such as an open mill, after cooling the mixture obtained during the first non-productive phase down to a lower temperature, typically of less than 120° C., for example between 40° C. and 100° C. The crosslinking system is then incorporated and the combined mixture is then mixed for a few minutes, for example between 5 and 15 min.

The final composition thus obtained is subsequently calendered, for example in the form of a sheet or of a plaque, in particular for a laboratory characterization, or also extruded in the form of a rubber semi-finished (or profiled) element which can be used, for example, as external sidewall of a tyre for a passenger vehicle.

The composition can be either in the raw state (before crosslinking or vulcanization) or in the cured state (after crosslinking or vulcanization), can be a semi-finished product which can be used in a tyre.

The curing can be carried out, in a way known to a person skilled in the art, at a temperature generally of between 130° C. and 200° C., under pressure, for a sufficient time which can vary, for example, between 5 and 90 min as a function in particular of the curing temperature, of the crosslinking system adopted, of the kinetics of crosslinking of the composition under consideration or also of the size of the tyre.

II-8 Use of the External Sidewall in a Tyre

The external sidewall described above is particularly well-suited to use as semi-finished or finished product, made of rubber, very particularly in a tyre for a motor vehicle, such as a vehicle of the two-wheel, passenger vehicle or industrial type.

It will be easily understood that, according to the specific fields of application, the dimensions and the pressures involved, the embodiment of the invention can vary; the external sidewall then comprises several preferential embodiments.

### III—EXAMPLES

III-1 Measurements and Test Used

Measurement of the Ozone Performance

The ozone resistance of the materials is measured according to the following method: after curing, 10 “B15” test specimens are subjected to a temperature of 38° C. and to an ozone content of 50 pphm (parts per hundred million) for a period of time of 240 hours.

The “BB5” test specimens result from an MFTR (known as Monsanto) plaque, the two beads of which located at the ends are used to hold the test specimen. Their dimensions are as follows: 78.5 mm*15 mm*1.5 mm.

The test specimens are subsequently placed on a trapezium at different elongations ranging from 10% to 100% in steps of 10% elongation. The extension value at which the test specimen breaks is taken into account. This makes possible a classification of the materials expressed as maximum percentage of elongation. The greater this percentage, the better the ozone resistance. A test specimen which does not break at 100% elongation exhibits a particularly high ozone resistance.

Dynamic Properties (Dynamic Shear Modulus (G*) and Loss Modulus (G″))

The dynamic properties G* and G″ are measured on a viscosity analyser (Metravib V A4000), according to Standard ASTM D 5992-96. The response of a sample of desired vulcanized composition (cylindrical test specimen with a thickness of 2 mm and a cross section of 78.5 mm²), subjected to a simple alternating sinusoidal shear stress, at a frequency of 10 Hz, at a temperature of 23° C. and according to Standard ASTM D 1349-99, is recorded. A peak-to-peak strain amplitude sweep is carried out from 0.1% to 50% (outward cycle) and then from 50% to 1% (return cycle). The results made use of are the complex dynamic shear modulus (G*) and the loss modulus (G″). For the return cycle, the value of G* at 20% strain and also the value of G″ at 20% strain are indicated.

For greater readability, the results are shown in base 100 (percentage), the value 100 being assigned to the control. A result of less than 100 will indicate an increase in the value concerned and, conversely, a result of greater than 100 will indicate a decrease in the value concerned. In other words, a percentage of greater than 100% means that the loss modulus G″ falls, indicating a decrease in the hysteresis and thus an improvement in the rolling resistance. Likewise, if the complex dynamic shear modulus G* falls, then the percentage relative to G* increases. In this case, the stiffness is improved, in particular for use in an external sidewall composition for a tyre.

Depth of Grooves

In order to measure the depth of grooves, use is made of a tyre sidewall test specimen with a square section (side 15 cm) and with a thickness of 9 mm obtained by moulding. The curing of the test specimens is carried out under a pressure of 16 bar at 170° C. for 15 minutes. The test specimen is fitted to the bed of a machine-tool. A cone made of hard steel with a length of 7 mm, the angle at the vertex of which is 75°, is attached to the tool holder of the machine. To produce the cones, the radius of curvature at the end is specified at less than 0.1 mm. The cones are cleaned before use. The cone, from the point of first contact (indentation), sinks in by 5 mm. After the desired sinking in has been obtained, the cone is moved parallel to the mixture plate, at a rate of 30 mm per second. The appearance of the scratches which appear at the rear of the cone subsequent to the tearing of the mixture is recorded at a sufficient distance, of the order of a centimetre, from the first point at which the cone was sunk into the mixture, so that the scratch observed is not affected by a possible transitory phenomenon and becomes independent of the length slid over.

In order to compare the sidewall which can be used according to the invention with the control sidewall, the confocal microscope is used to measure the depth of the scratches. Each measurement by confocal microscopy is carried out at three different points (two on the rubber close to the scratch and one at the bottom of the scratch), where the latter is sufficiently open for the measurement to be able to be carried out.

This measurement of the scratch depth is carried out at ten different sites of the scratch and then the mean of the ten depth measurements is calculated. For greater readability, the results will be shown in base 100 (percentage), the value 100 being assigned to the control. A result greater than 100 indicates a decrease in the value concerned.

Thus, a percentage of greater than 100% means that the scratch is not as deep as that of the reference tyre sidewall.

III-2 Preparation of the Compositions

The tests which follow are carried out in the following way: the diene elastomer, the thermoplastic elastomer, the reinforcing filler and also the various other ingredients, with the exception of the vulcanization system, are successively introduced into an internal mixer (final degree of filling: approximately 70% by volume), the initial vessel temperature of which is approximately 60° C. Thermomechanical working (non-productive phase) is then carried out in one stage, which lasts in total approximately from 3 to 4 min, until a maximum “dropping” temperature of 150° C. is reached.

The mixture thus obtained is recovered and cooled and then sulfur and the vulcanization accelerator are incorporated on a mixer (homofinisher) at 30° C., everything being mixed (productive phase) for an appropriate time (for example between 5 and 12 min).

The compositions thus obtained are subsequently calendered, either in the form of plaques (thickness of 1 to 3 mm) or of thin sheets of rubber, for the measurement of their physical or mechanical properties.

The samples thus produced were cured for 25 minutes at 150° C. in a bell press. The samples were analysed after having been cooled at ambient temperature for 24 hours.

The processing of the elastomeric compositions is carried out by means of a mixer of the Haake RM 3000 type of 360 cm³ with blades of CAM type.

III-3 Rubber Test

The object of the examples presented below is to compare the effect of substituting the natural rubber with a thermoplastic elastomer used in the context of the present invention on the resistance to outside attacks. Their formulations (in phr) and their properties have been summarized in Table 1 below.

TABLE 1

| Ingredients | A | B |
|---|---|---|
| Polybutadiene⁽¹⁾ | 65 | 65 |
| Natural rubber | 35 | — |
| SBS⁽²⁾ | — | 35 |
| Carbon black⁽³⁾ | 50 | 50 |
| Oil⁽⁴⁾ | 15 | 15 |
| Antioxidant⁽⁵⁾ | 3.0 | 3.0 |
| Antiozone wax⁽⁶⁾ | 1.0 | 1.0 |
| Stearic acid | 1.0 | 1.0 |
| Zinc oxide⁽⁷⁾ | 2.4 | 2.4 |
| Sulfur | 1.4 | 1.4 |
| Accelerator⁽⁸⁾ | 1.4 | 1.4 |
| Groove | 100 | 132 |

(1) BR ND ML63
(2) Block copolymer comprising 31% by weight of styrene of the D1101 series from Kraton
(3) Carbon black N550 (name according to Standard ASTM D-1765) from Cabot
(4) MES oil, Catenex SNR from Shell
(5) Antioxidant, Santoflex 6PPD from Solutia
(6) Antiozone wax, Varazon 4959 from Sasol Wax
(7) Zinc oxide (industrial grade - Umicore)
(8) Accelerator, Santocure CBS from Solutia

It can be seen that the tyres according to provided with the sidewall B exhibits an improved resistance to attack compared with the reference tyre provided with the sidewall A.

Other examples have been carried out in order to compare the resistance to ozone and the stiffness of compositions in accordance with the invention (I1 to I5) with that of a control composition (C1) conventionally used for the external sidewall for a tyre, and also with a control composition (C2) whose only difference from the compositions in accordance with the invention is the content of antiozone wax. Their formulations (in phr) and their properties have been summarized in Table 2 below.

TABLE 2

| Ingredients | Cl | C2 | I1 | I2 | I3 | I4 | I5 |
|---|---|---|---|---|---|---|---|
| Polybutadiene⁽¹⁾ | 65 | 75 | 75 | 75 | 75 | 75 | 75 |
| Natural rubber | 35 | — | — | — | — | — | — |
| SBS⁽²⁾ | — | 25 | 25 | 25 | 25 | 25 | 25 |
| Carbon black⁽³⁾ | 50 | 25 | 25 | 25 | 25 | 25 | 25 |
| Oil⁽⁴⁾ | 20 | 15 | 15 | 15 | 15 | 15 | 15 |
| Antioxidant⁽⁵⁾ | 3.0 | 3.0 | 3.0 | 3.0 | 3.0 | 3.0 | 3.0 |
| Antiozone wax⁽⁶⁾ | 1.0 | 1.0 | 0.8 | 0.6 | 0.4 | 0.2 | |
| Stearic acid | 1.0 | 1.0 | 1.0 | 1.0 | 1.0 | 1.0 | 1.0 |
| Zinc oxide⁽⁷⁾ | 3.0 | 2.4 | 2.4 | 2.4 | 2.4 | 2.4 | 2.4 |
| Sulfur | 1.4 | 1.2 | 1.2 | 1.2 | 1.2 | 1.2 | 1.2 |
| Accelerator⁽⁸⁾ | 1.4 | 1.2 | 1.2 | 1.2 | 1.2 | 1.2 | 1.2 |
| Maximum | 50 | 60 | 80 | No | 100 | 90 | 70 |
| extension (%) | | | | break | | | |
| G* modulus at 10% | 100 | 108 | 102 | 102 | 104 | 102 | 100 |
| strain | | | | | | | |

(1) to (8): See Table 1

These results show the compositions in accordance with the invention make it possible to improve the resistance to ozone, in comparison with the control compositions, while allowing dynamic properties (the stiffness G*) in accordance with use in the external sidewall for tyres. It has furthermore been found that the compositions in accordance with the invention exhibit very good resistances to the rolling resistance (G″).

The effect of reducing antiozone wax on compositions conventionally used in the external sidewall C3, C4 and C5 (not in accordance with the present invention) was measured in the same way as described above. Their formulations (in phr) and their properties have been summarized in Table 3 below.

TABLE 3

| Ingredients | C3 | C4 | C5 |
|---|---|---|---|
| Polybutadiene⁽¹⁾ | 65 | 65 | 65 |
| Natural rubber | 35 | 35 | 35 |
| Carbon black⁽³⁾ | 50 | 50 | 50 |
| Oil⁽⁴⁾ | 18 | 18 | 18 |
| Antioxidant⁽⁵⁾ | 3.0 | 3.0 | 3.0 |
| Antiozone wax⁽⁶⁾ | 1.5 | 1.0 | 0 |
| Stearic acid | 1.0 | 1.0 | 1.0 |
| Zinc oxide⁽⁷⁾ | 2.4 | 3.0 | 2.4 |
| Sulfur | 1.4 | 1.4 | 1.4 |
| Accelerator⁽⁸⁾ | 1.4 | 1.4 | 1.4 |
| Maximum | 70 | 50 | 50 |
| extension (%) | | | |

(1) to (8): See Table 1

These results show that, in contrast to the compositions in accordance with the invention containing a thermoplastic elastomer, the external sidewall compositions conventionally used in tyres exhibit a reduced resistance to ozone when the quantity of antiozone wax is reduced. Moreover, it has been observed for control C5 that cracks appeared very early, from 10% elongation, implying a particularly weak resistance to ozone.

On the contrary, and surprisingly, the compositions in accordance with the invention, comprising a diene elastomer selected from the group consisting of butadiene polymers having a glass transition temperature of less than or equal to −50° C., and a thermoplastic elastomer comprising at least one elastomer block and at least one thermoplastic block, the thermoplastic elastomer not comprising a polyisobutylene block, exhibits an improved resistance to ozone when the quantity of antiozone wax is reduced.

1.-21. (canceled)

22. A tire provided with an external sidewall, the external sidewall comprising a composition based on at least:
an elastomeric matrix comprising at least one diene elastomer selected from the group consisting of butadiene polymers having a glass transition temperature of less than or equal to −50° C. and a thermoplastic elastomer comprising at least one elastomer block and at least one thermoplastic block, the thermoplastic elastomer not comprising a polyisobutylene block;
a crosslinking system; and
a reinforcing filler,
wherein the composition does not comprise antiozone wax or comprises less than 1.0 phr, where phr is part by weight per hundred parts of elastomer.

23. The tire according to claim 22, wherein the elastomer block of the thermoplastic elastomer exhibits a glass transition temperature of less than or equal to −50° C.

24. The tire according to claim 22, wherein the at least one elastomer block of the thermoplastic elastomer is selected from the group consisting of non-hydrogenated or partially hydrogenated polyisoprenes, non-hydrogenated or partially hydrogenated polybutadienes, non-hydrogenated or partially hydrogenated copolymers of styrene and of butadiene, and mixtures thereof.

25. The tire according to claim 22, wherein the at least one thermoplastic block of the thermoplastic elastomer is selected from the group consisting of polyolefins, polyurethanes, polyamides, polyesters, polyacetals, polyethers, polyphenylene sulfides, polyfluorinated compounds, polystyrenes, polycarbonates, polysulfones, poly(methyl methacrylate), polyetherimide, thermoplastic copolymers and mixtures thereof.

26. The tire according to claim 22, wherein the at least one thermoplastic block of the thermoplastic elastomer is selected from the group consisting of polystyrenes, polyesters, polyamides, polyurethanes and mixtures thereof.

27. The tire according to claim 22, wherein the thermoplastic elastomer is selected from the group consisting of styrene/butadiene (SB), styrene/isoprene (SI), styrene/butadiene/isoprene (SBI), styrene/butadiene/isoprene/styrene (SBIS), styrene/butadiene/styrene (SBS), styrene/isoprene/styrene (SIS) and styrene/optionally partially hydrogenated butadiene-styrene copolymer/styrene (SOE) block copolymers and mixtures thereof.

28. The tire according to claim 22, wherein the thermoplastic elastomer is selected from the group consisting of styrene/butadiene/styrene (SBS) and styrene/optionally partially hydrogenated butadiene-styrene copolymer/styrene (SOE) block copolymers and mixtures thereof.

29. The tire according to claim 22, wherein a content of thermoplastic elastomer in the composition is within a range extending from 1 to 50 phr.

30. The tire according to claim 22, wherein the at least one diene elastomer is selected from the group consisting of polybutadienes, butadiene copolymers, preferably butadiene/styrene copolymers, isoprene/butadiene copolymers and isoprene/butadiene/styrene copolymers, and mixtures thereof.

31. The tire according to claim 22, wherein a content of the at least one diene elastomer in the composition is within a range extending from 50 to 99 phr.

32. The tire according to claim 22, wherein the antiozone wax is present and is selected from the group consisting of paraffin waxes, Fischer-Tropsch waxes and mixtures thereof.

33. The tire according to claim 22, wherein the antiozone wax is present and comprises predominantly linear or branched hydrocarbon chains, the number of carbon atoms of which is within a range extending from 18 to 70.

34. The tire according to claim 22, wherein the antiozone wax is present and a ratio of branched (iso)/unbranched (normal) hydrocarbon chains in the antiozone wax is within a range extending from 0/100 to 80/20.

35. The tire according to claim 22, wherein the content of antiozone wax in the composition is 0 phr.

36. The tire according to claim 22, wherein the antiozone wax is present and the content of antiozone wax in the composition is within a range extending from 0.1 to 0.9 phr.

37. The tire according to claim 22, wherein the crosslinking system is based on molecular sulfur, on a sulfur-donating agent, or on both molecular sulfur and a sulfur-donating agent.

38. The tire according to claim 37, wherein a content of sulfur or of sulfur donor, in the composition, is between 0.5 and 2 phr.

39. The tire according to claim 22, wherein the reinforcing filler comprises carbon black, silica or both carbon black and silica.

40. The tire according to claim 22, wherein the reinforcing filler predominantly comprises carbon black.

41. The tire according to claim 22, wherein a content of reinforcing filler, in the composition, is within a range extending from 5 to 70 phr.
